(19) United States
(12) Patent Application Publication
(10) Pub. No.: US 2001/0000096 A1
(43) Pub. Date: Apr. 5, 2001

(54) Tape dispenser

(76) Inventors: Gary E. Tolerico, Coteur d' Alane, ID (US); Ron D. Shaw, Corona Del Mar, CA (US); Lee A. Shaw, Newport Beach, CA (US); Scott G. Shaw, Cost Mesa, CA (US); Michael J. Davis, San Clemente, CA (US); Paul J. Taylor, La Habra, CA (US)

Correspondence Address: Kit M. Stetina, STETINA BRUNDA GARRED & BRUCKER, Suite 250, 75 Enterprise, Aliso Viejo, CA, 92656, US

(21) Appl. No.: 09/729,444

(22) Filed: Dec. 4, 2000

Related U.S. Application Data
(63) Continuation of application No. 09/197,264, filed on Nov. 20, 1998.

(51) Int. Cl. B32B 3/04; B31F 1/00

(52) U.S. Cl. 156/200; 156/465; 428/121; 428/124

(57) ABSTRACT

A tape dispenser folds over an edge portion of a strip of masking tape while the masking tape is being dispensed therefrom. The masking tape may then be used to effect feathering or blending of paint sprayed on a desired surface, such as an automobile body or the like. The tape dispenser has a holder for holding at least one roll of masking tape and also has a tape guide configured to cause the masking tape dispensed from the tape holder to fold over and to adhere to itself when the masking tape is manually pulled against the tape guide.

### FIELD OF THE INVENTION

1. The present invention relates generally to devices for dispensing materials from rolls and relates more particularly to a tape dispenser for folding over an edge portion of a strip of masking tape as the masking tape is dispensed therefrom.

### BACKGROUND OF THE INVENTION

2. Tape dispensers for dispensing masking tape from a roll for use in auto body shops and the like are well known. Such tape dispensers allow a user to obtain a desired length of masking tape simply by pulling the desired length of masking tape from the roll and then tearing or cutting it away from the roll.

3. However, as those skilled in the art will appreciate, it is frequently desirable to fold over an edge portion of a strip of masking tape so as to facilitate use of the strip of masking tape for blending or feathering of sprayed paint.

4. Masking tape is often used to mask off those portions of an automobile body or the like for which it is undesirable to inadvertently paint. Such inadvertent painting may occur when the area to be painted is over sprayed and the over sprayed paint strikes a portion of the automobile body or the like which is not to be painted. Thus, masking tape, usually in combination with masking paper, is commonly used to avoid such over spraying of paint.

5. However, as those skilled in the art will further appreciate, the use of masking tape in this manner results in a straight, well defined edge of the newly painted area. Generally, it is preferable to have the painted edge be blended or feathered rather than straight and well defined, so as to best match the adjacent unpainted area. Such blending or feathering may be accomplished by sanding, rubbing and/or polishing the well defined line between the painted area and the unpainted area after the paint dries and the masking tape is removed. However, this is a very time consuming and laborious task.

6. In an attempt to avoid the undesirable sanding, rubbing, and/or polishing necessary to accomplish such blending of the new paint with the adjacent old paint, it is known to use masking tape which has an edge portion thereof folded over such that the folded over edge portion does not adhere to the automobile body or the like. The folded over edge portion of the masking tape may then be angled upwardly, away from the auto body, such that when the desired area of the automobile body or the like is painted, a portion of the paint is sprayed beneath the upwardly angled folded edge portion of the masking tape in a manner which effects some degree of such desired blending or feathering. The use of masking tape having such a folded over edge portion thus eliminates or substantially reduces the amount of blending or feathering which must substantially be performed after the paint dries.

7. However, forming the folded over edge portion of a strip of masking tape is undesirably labor intensive and time consuming. When performed manually, such folding over requires that desired length of the masking tape be obtained from a tape dispenser, then the desired edge portion thereof is folded, one small section at a, time, until the edge of the entire length of masking tape has been folded over. This is inherently a slow and tedious process.

8. In an attempt to mitigate the time and effort required to manually fold over a portion of a length of tape, U.S. Pat. No. 4,576,674 teaches the use of an edge bending masking tape dispenser which appears to automatically fold over an edge portion of masking tape as it is dispensed therefrom. However, it is apparent from the disclosure of U.S. Pat. No. 4,576,674 that the device disclosed therein is relatively complex and consequently is comparatively expensive to manufacture. The device of U.S. Pat. No. 4,576,674 device has an undesirably long and complex tape path which necessitates the use of an undesirably large number of components, consequently undesirably increasing the cost thereof.

9. In view of the forgoing, it is desirable to provide a tape dispenser which automatically folds over a desired edge portion of a length of masking tape dispensed therefrom and which has a comparatively short and simple tape path so as to facilitate simple and inexpensive manufacture thereof.

### SUMMARY OF THE INVENTION

10. The present invention specifically addresses and alleviates the above mentioned deficiencies associated with the prior art. More particularly, the present invention comprises a tape dispenser for folding over an edge portion of a strip of masking tape as the masking tape is dispensed therefrom. The tape dispenser comprises a tape holder, preferably a reel, for holding at least one roll of masking tape and a tape guide which is configured to cause masking tape dispensed from the tape holder to fold over and to adhere to itself when masking tape is manually pulled against the tape guide as the masking tape is dispensed therefrom.

11. Thus, the tape dispenser preferably comprises at least one reel upon which a roll of masking tape is disposable. At least one tape guide, the number of tape guides corresponding to the number of reels, comprises a channel through which the masking tape passes as it is removed from the associated reel. A tape form extends from the channel of the tape guide and is configured so as to fold over an edge portion of the masking tape as the masking tape passes thereby, so as to form a folded over edge portion of the masking tape. A lip is formed upon the tape guide and is configured such that when the masking tape is pulled against the lip, then the folded over edge portion of the masking tape is caused to adhere to a laminarly juxtaposed portion the masking tape. That is, the masking tape is folded over and adheres to itself.

12. The tape form bends or folds over an edge portion of the masking tape. The tape form positions the folded over edge portion of the masking tape proximate a remaining, laminarly juxtapositioned portion of the masking tape, such that when the masking tape is pulled against the tape guide, the folded over edge portion is caused to come into intimate contact with the laminarly juxtaposed remaining portion of the masking tape in a manner which causes it to adhere thereto.

13. According to the present invention, a length of masking tape having a well creased, folded over edge portion is provided. A desired length of such folded over masking tape is provided by merely grasping the exposed distal end of the masking tape and pulling, preferably downwardly, against the tape guide until the desired length of masking tape has been folded over and dispensed therefrom. Then the length of masking tape is merely torn from the roll, preferably at the distal end of the tape guide, so as to leave an exposed distal end of the masking tape which readily facilitates dispensing of another desired length of masking tape.

14. Such dispensed folded over lengths of masking tape may then be utilized to mask off those portions of an automobile body or the like which are to be protected from over spraying. By angling the folded over portion of the masking tape upwardly, away from the surface to which it has been applied, the folded over edge portion of the masking tape forms a small overhang which causes paint sprayed theretoward to blend or feather, so as to eliminate or mitigate the need to manually effect such blending by utilizing sandpaper, rubbing compound, etc.

15. According to the preferred embodiment of the present invention, the tape guide is configured such that pulling the masking tape downward thereagainst causes a folded over edge portion of the masking tape to adhere to the laminarly juxtaposed portion of the masking tape. In this way, the masking tape can be dispensed in a manner similar to that in which rolled products are typically dispensed from the rolls, i.e., simply by pulling the masking tape off of the roll, through the tape guide.

16. The reels preferably comprise a plurality of reels, each of which is configured to hold a different size of masking tape. The tape guide(s) preferably comprise a corresponding plurality of tape guides, each of the corresponding plurality of tape guides being dedicated to one of the reels.

17. According to the preferred embodiment of the present invention, the reels comprise two reels, each of the two reels being configured to hold a different size of masking tape, preferably ½ inch wide masking tape and ¾ inch wide masking tape.

18. The lip of the tape guide is preferably straight and is preferably approximately proximately orthogonal the direction in which the masking tape moves as it is dispensed. However, those skilled in the art will appreciate that various different configurations of the lip are likewise suitable. For example, the lip may form an angle with respect to the motion in which masking tape is moved as it is dispensed, so as to facilitate the tape being removed from the dispenser at a corresponding angle. This may be convenient when the dispenser is mounted near obstruction, such as a wall, thus making it desirable to pull the masking tape away from the wall at a slight angle.

19. The lip must be configured such that pulling the masking tape against the lip causes the folded over edge portion of the masking tape to adhere to the remaining portion thereof. Those skilled in the art will appreciate that various configurations of the lip are suitable.

20. The tape forms of the present invention preferably have a generally rectangular cross section. However, those skilled in the art will appreciate that various other cross sections of the forms are likewise suitable.

21. Optionally, a dedicated guide roller for each reel is positioned so as to bias the masking tape dispensed from the roll against the tape form, so as to assure that masking tape dispensed from a tape reel is folded over in the desired manner. Those skilled in the art will appreciate that various other means for biasing the masking tape dispensed from the roll against the tape form are also suitable.

22. Thus, according to the present invention, masking tape is dispensed having a folded over portion by manually pulling the masking tape from the tape holder and simultaneously pulling the masking tape against a tape guide. The tape guide is configured to cause masking tape to fold over and adhere to itself when the masking tape is pulled thereagainst.

23. More particularly, the masking tape is preferably dispensed by manually pulling masking tape from a reel upon which a roll of masking tape is disposed. The tape guide is preferably configured such that masking tape is pulled downward thereagainst so as to effect adhering of masking tape to itself at the folded over portion thereof. As those skilled in the art will appreciate, the tape guide may be configured so as to facilitate the dispensing of masking tape therefrom in any desired direction. It is generally preferred that the tape be dispensed by pulling it downwardly since that is consistent with how most tape dispensers operate.

24. As the masking tape is pulled, it is dispensed from the roll thereof and preferably passes through a channel formed in the tape guide. The tape form, which is disposed within the channel of the tape guide, folds over an edge portion of the masking tape as masking tape passes thereby. Optionally, the guide roller guides the masking tape into the tape guide at the desired angle so as to insure that the masking tape contacts the tape form in a manner which reliably effects bending over of an edge portion thereof.

25. These, as well as other advantages of the present invention will be more apparent from the description and drawings. It is understood that changes in the specific structure shown and described may be made within the scope of the claims without departing from the spirit of the invention.

### BRIEF DESCRIPTION OF THE DRAWINGS

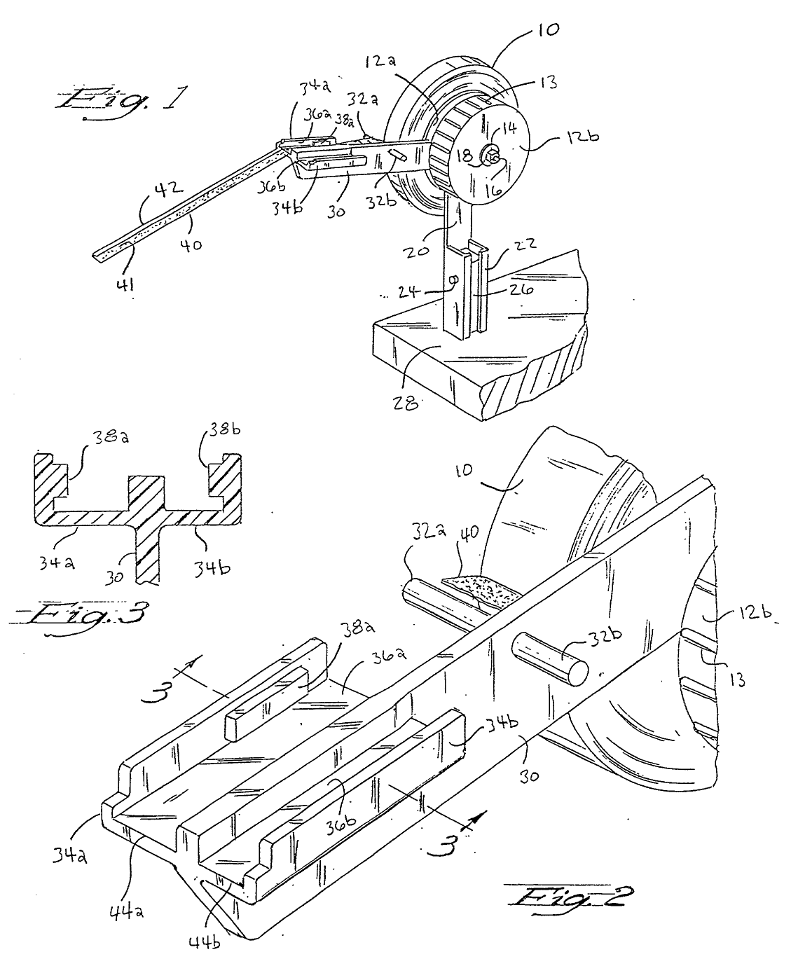

26. FIG. 1 is a perspective view of the tape dispenser of the present invention showing a length of masking tape being dispensed therefrom such that an edge portion of the masking tape is folded down and adhered to a laminarly juxtaposed portion of the masking tape in a manner which facilitates paint blending;

27. FIG. 2 is an enlarged perspective view of two tape guides according to the present invention, wherein the two guides are formed as an integral unit and are configured to fold over two different sizes of masking tape;

28. FIG. 3 is a cross section of the tape guides of FIG. 2, taken along lines 3 thereof;

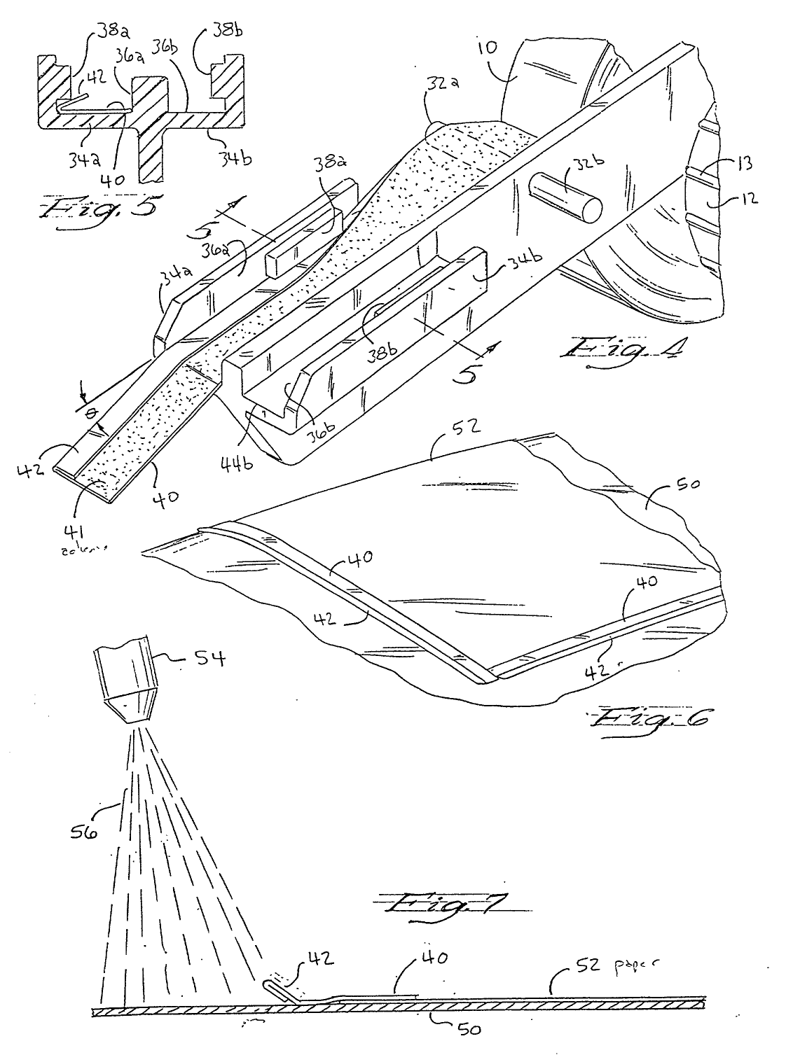

29. FIG. 4 is an enlarged perspective view of the masking tape guides of FIG. 1, showing masking tape passing through one of the tape guides and having an edge portion of the masking tape folded over so as to adhere to a laminarly juxtaposed remaining portion thereof;

30. FIG. 5 is a cross section taken along lines of FIG. 4, showing masking tape being folded over by the tape form;

31. FIG. 6 is a perspective view showing an area of an automobile body or the like which is masked off, so as to prevent over spraying of paint thereonto, wherein a folded over edge portion of the masking tape effects desirable blending of paint sprayed theretoward; and

32. FIG. 7 is an enlarged side view of one of the strips of masking tape of FIG. 6, having paint sprayed proximate thereto such that the upwardly angled, folded over edge of the masking tape effects the desired blending of the paint along the length thereof.

### DETAILED DESCRIPTION OF THE PREFERRED INVENTION

33. The detailed description set forth below in connection with the appended drawings is intended as a description of the presently preferred embodiment of the invention, and is not intended to represent the only form in which the present invention may be constructed or utilized. The description sets forth the functions and the sequence of steps for constructing and operating the invention in connection with the illustrated embodiment. It is to be understood, however, that the same or equivalent functions may be accomplished by different embodiments that are also intended to be encompassed within the spirit and scope of the invention.

34. The tape dispenser of the present invention is illustrated in FIGS. 1 through 5 which depict a presently preferred embodiment thereof. FIGS. 6 and 7 show the masking tape having an edge portion thereof folded over and being used to mask off an area of an automobile body or the like in a manner which facilitates blending of paint sprayed thereon.

35. Referring now to FIG. 1, the tape dispenser of the present invention generally comprises at least one, preferably two or more reels, 12a, 12a upon which a roll of masking tape 10 is placed so as to effect dispensing thereof. Protrusions 13 formed upon the outer circumference of each reel 12a, 12a facilitate secure attachment of the roll of masking tape 10 to the reel 12a, 12a.

36. Nut 14, bolt 16, and washer 18 are used to rotatably attach the reels 12a, 12a, to support leg 20, which preferably extends vertically upward from a surface 28 to which the tape dispenser is mounted.

37. Mount 22 receives square post 26 which extends vertically from surface 28 and is attached thereto. Bolt, pin, or other fastener 24 passes through mount 22 and square post 26 to attach the tape dispenser to surface 28. Those skilled in the art will appreciate that various other means for mounting the tape dispenser are likewise suitable. For example, various types of fasteners, clamps, pins, etc., may be utilized, if desired.

38. Referring now to FIG. 2, support arm 30 extends from support leg 20. Roller guides 32a, 32b are positioned so as to cause masking tape 40 from tape roll 10 to enter tape guides 34a, 34b at a desired angle, as discussed in detail below. Tape guides 34a, 34b are formed upon the distal end of support arm 30 and are configured to cause the masking tape 40 to bend or fold over so as to form a folded over edge portion thereof.

39. More particularly, the tape guides 34a, 34b comprise channels 36a, 36b through which masking tape 40 passes of the masking tape 40 is dispensed. Tape forms 38a, 38b (shown in FIGS. 3, 4, and 5) cause masking tape 40 to fold over as it passes through the channels 36a, 36b of the tape guides 34a, 34b.

40. Lips 44a, 44b, formed at the distal ends of, tape guides 34a, 34b, respectively, are utilized to cause the folded over portion 42 of the masking tape 40 to adhere to the laminarly juxtaposed portion of the masking tape 40 when a user pulls downwardly upon the masking tape 40 as it is being dispensed, as shown in FIGS. 1 and 4. The lips 44a, 44b of the tape dispenser of the present invention are substantially smooth, rather than serrated as in contemporary dispensers. As those skilled in the art will appreciate, contemporary tape dispensers comprise a knife or cutter which defines the lip thereof and which is used to effect cutting off of the desired length of masking tape from the roll. Thus, when such a contemporary tape dispenser is utilized, the masking tape is pulled from a dispenser in a manner which avoids contact between the tape being dispensed and the serrated knife or cutter of the contemporary tape dispenser (typically by angling the masking tape upwardly as it is pulled). Then, when the desired length of masking tape has been pulled from the roll, the masking tape is pulled downwardly such that it contacts the serrated edge of the cutter or knife and is thus cut away from the roll.

41. The operation of the present invention is distinctly different from that of a contemporary tape dispenser in that according to the present invention substantially constant pressure is applied to the masking tape 40 being dispensed so as to maintain it in contact with the lip 44a, 44b of the tape guide 34a, 34b. This effects desired adhesion of the folded over edge portion 42 of the masking tape 40 to the remaining laminarly juxtaposed portion of the masking tape 40. More particularly, such adhesion is effected by pulling the masking tape downwardly, at an angle θ in a manner which maintains substantially constant contact between the masking tape being dispensed and the lip 44a, 44b of the tape dispenser. This is in direct contrast to the above described operation of a contemporary tape dispenser, wherein such downward pressure is only applied after the desired quantity of tape has been dispensed and when it is desired to cut the tape.

42. As those skilled in the art will appreciate, tape can not even be dispensed from a contemporary tape dispenser in the same manner that it is dispensed from the present invention, since such operation of a contemporary tape dispenser would necessarily result in undesirable contact between the tape being dispensed and the serrated knife or cutter of the contemporary tape dispenser, thereby either undesirably scoring the tape being dispensed, undesirably cutting the tape being dispensed away from the roll, or undesirably jamming the tape being dispensed such that a desired length thereof is not dispensed from the roll.

43. The generally straight or non-serrated lip 44a, 44b of the present invention provides very simple, low cost means for effecting the desired adhesion of the folded over edge portion 42 of the masking tape 40 to the remaining, laminarly juxtaposed, portion thereof.

44. It has been found that, after the desired length of masking tape 40 has been dispensed from the reel 10, then it may be torn away from the roll 10 by simply increasing the angle θ to a point where the masking tape no longer slides easily over the lip 44a, 44b, and then the masking tape may be torn away.

45. Referring now to FIG. 3, tape forms 38a, 38b are preferably generally rectangular in cross section. However, those skilled in the art will appreciate that various other cross sectional configurations of the tape forms 38a, 38b are likewise suitable.

46. Referring now to FIGS. 5-7, use of the tape dispenser of the present invention is shown. With particular reference to FIGS. 4 and 5, it can be seen that as masking tape 41 passes by tape form 38a, it is caused to fold over by tape form 38a so as to define folded over edge portion 42 thereof. It can further be seen that pulling downwardly upon the distal end of masking tape 40 causes it to travel over lip 44a (FIG. 2) in a manner which assures that folded over edge portion 42 of the masking tape 41 adheres reliably to the laminarly juxtaposed remaining portion of the masking tape 40.

47. The angle θ by which the masking tape 40 is bent downwardly as it passes over the lip 44a, 44b as the masking tape 40 is dispensed will typically be between approximately 5 degrees and 85 degrees, typically approximately 10 degrees. The angle θ will typically be between approximately 45 and 90 degrees, typically approximately 85 degrees, when tearing the masking tape 40 away from the roll 10.

48. Thus, in order to dispense a desired length of masking tape 40 from the tape dispenser of the present invention, the user merely pulls the distal end of the masking tape 40 out and away from the roll 10 while simultaneously pulling downwardly at angle θ so as to cause the masking tape 40 to adhere to itself, i.e., folded over edge portion 42 to adhere to the remaining laminarly juxtaposed portion of tape 40.

49. Referring now to FIG. 6, masking tape 40 so dispensed is utilized to mask off a desired portion of automobile body or the like 50 as to prevent over spraying of paint thereonto when an adjacent portion of the automobile body or the like 50 is spray painted. Masking paper 52 substantially covers that portion of the automobile body or the like 50 where such over spraying is to be mitigated. Masking tape 40 is used to hold the masking paper 52 in place.

50. Referring now to FIG. 7, the masking tape is applied such that the folded over edge portion thereof is upturned or angled away from the automobile body or the like 50. When the automobile or the like 50 is spray painted, a portion of the paint is sprayed beneath the upwardly angled folded over edge portion 42 of the masking tape 40. This area is partially shielded from the spray paint 56 such that it receives only a portion thereof, thereby resulting in feathering or blending of the paint beneath the angled up folded edge portion 42 of the masking tape 40.

51. Thus, according to the present invention, a low cost, easy to use tape dispenser having simplified construction is provided.

52. It is understood that the exemplary tape dispenser described herein and shown in the drawings represents only a presently preferred embodiment of the invention. Indeed, various modifications and additions may be made to such embodiment without departing from the spirit and scope of the invention. For example, various means for attaching the tape dispenser to a desired surface or object are contemplated. Further, various different configurations of the tape guide and the tape form are suitable for effecting folding over of the masking tape as it passes through the tape guide. More particularly, various shapes and configurations of the tape form are contemplated. For example, the tape form may have various different cross sectional configurations, e.g., round, oval, square, triangular, etc. Indeed, the tape form need not have a cross-sectional shape which corresponds generally to a well known geometric shape. Rather, the tape form may be configured so as to have various different desired cross sectional configurations and shapes. Further, the present invention may be utilized to fold over various different types of adhesive tape, and thus is not limited merely to masking tape. The specific reference to masking tape herein is by way of example only, and not by way of limitation. Thus, these and other modifications and additions may be obvious to those skilled in the art and may be implemented to adapt the present invention for use in a variety of different applications.

What is claimed is:

1. A tape dispenser for folding over an edge portion of a strip of tape as the tape is dispensed therefrom, the tape dispenser comprising:
a) a tape holder for holding at least one roll of tape; and
b) a tape guide configured to cause tape dispensed from the tape holder to fold over and to adhere to itself when the tape is manually pulled against the tape guide.

2. A tape dispenser for folding over an edge portion of a strip of tape and for causing the tape to adhere to itself as the tape is dispensed therefrom, the tape dispenser comprising:
a) at least one reel upon which a roll of tape is disposable;
b) at least one tape guide comprising a channel, the tape guide being configured such that tape passes through the channel thereof as it is removed from the reel;
c) a tape form extending from the channel of the tape guide and configured to fold over an edge portion of the tape as the tape passes thereby so as to form a folded over edge portion of the tape; and
d) a lip formed upon the tape guide and configured such that when the tape is pulled against the lip, then the folded over edge portion of the tape is caused to adhere to a laminarly juxtaposed portion of the tape.

3. The tape dispenser as recited in claim 2, wherein the lip is configured such that pulling the tape downward thereagainst causes the folded over edge portion of the tape to adhere to the laminarly juxtaposed portion of the tape.

4. The tape dispenser as recited in claim 2, wherein:
a) the reel(s) comprise a plurality of reels, each of the plurality of reels being configure to hold a different size of tape; and
b) the tape guides comprise a corresponding plurality of tape guides, each of the corresponding plurality of tape guides being dedicated to one of the reels.

5. The tape dispenser as recited in claim 2, wherein the reel(s) comprise two reels, each of the two reels being configured to hold a different size of tape.

6. The tape dispenser as recited in claim 2, wherein the lip is generally straight.

7. The tape dispenser as recited in claim 2, wherein the lip is generally straight and is approximately orthogonal to a direction in which the tape moves as the tape is dispensed.

8. The tape dispenser as recited in claim 2, wherein each tape form comprises a protrusion having a generally rectangular cross-section.

9. The tape dispenser as recited in claim 2, further comprising a dedicated guide roller for each reel, the dedicated guide roller being positioned so as to bias tape dispensed from the reel against a tape form.

10. A method for dispensing tape having a folded over edge portion, the method comprising the steps of:
a) manually pulling tape from a tape holder; and
b) simultaneously pulling the tape against a tape guide, the tape guide being configured to cause the tape to fold over and to adhere to itself when the tape is pulled thereagainst.

11. The method as recited in claim 10, wherein the step of manually pulling the tape from a tape holder comprises manually pulling the tape from a reel upon which a roll of tape is disposed.

12. The method as recited in claim 10, wherein the step of pulling the tape against a tape guide comprises pulling the tape downward against the tape guide.

13. The method as recited in claim 10, wherein the step of pulling the tape against a tape guide comprises pulling the tape against a lip of the tape guide.

14. The method as recited in claim 10, wherein the step of pulling the tape against a tape guide comprises pulling the tape through a channel formed in the tape guide.

15. The method as recited in claim 10, wherein the step of pulling the tape against a tape guide comprises
pulling the tape past a tape form extending from the tape guide, the tape form folding over an edge portion of the tape as the tape passes thereby.

16. The method as recited in claim 10, further comprising the step of biasing the tape against a tape form with a guide roller.

17. Tape having a folded over edge portion thereof made according to a process comprising the steps of:
a) manually pulling tape from a tape holder; and
b) while manually pulling the tape from the tape holder, simultaneously pulling the tape against a tape guide, the tape guide being configured to cause the tape to fold over and to adhere to itself when the tape is pulled thereagainst.

18. The tape as recited in claim 17, wherein the step of manually pulling the tape from a tape holder comprises manually pulling the tape from a reel upon which a roll of tape is disposed.

19. The tape as recited in claim 17, wherein the step of pulling the tape against a tape guide comprises pulling the tape downward against the tape guide.

20. The tape as recited in claim 17, wherein the step of pulling the tape against a tape guide comprises pulling the tape against a lip of the tape guide.

21. The tape as recited in claim 17, wherein the step of pulling the tape against a tape guide comprises pulling the tape through a channel formed in the tape guide.

22. The tape as recited in claim 17, wherein the step of pulling the tape against a tape guide comprises pulling the tape past a tape form extending from the tape guide, the tape form folding over an edge portion of the tape as the tape passes thereby.

23. The tape as recited in claim 17, further comprising the step of biasing the tape against a tape form with a guide roller.
